(19) United States
(12) Patent Application Publication
(10) Pub. No.: US 2026/0320053 A1
(43) Pub. Date: Oct. 15, 2026

(54) OBSERVATION-BASED CACHE INVALIDATION SYSTEM

(71) Applicant: CAST AI Group, Inc., Miami, FL (US)

(72) Inventors: Benjamin Gray, Reading (GB); Luka Androjna, Ljubljana (SI); Viktoras Makauskas, Vilnius (LT); Karolis Kusas, Kaunas (LT)

(21) Appl. No.: 19/643,184

(22) Filed: Apr. 9, 2026

Related U.S. Application Data
(60) Provisional application No. 63/785,695, filed on Apr. 9, 2025.

(51) Int. Cl. G06F 16/2455

(52) U.S. Cl. CPC G06F 16/24552

(57) ABSTRACT

A cache invalidation method, that comprises tracking, by a processor, query patterns to identify invalidation relationships between a plurality of data manipulation language (DML) queries and payload changes of a plurality of data query language (DQL) queries stored in a query cache; generating, by the processor, a plurality of DML-DQL pairs based on the invalidation relationships, each of the plurality of DML-DQL pairs represents a unique pairing of a DML query from the plurality of DML queries and a DQL query from the plurality of DQL queries; generating, by the processor, a data model using the plurality of DML-DQL pairs; receiving, by the processor, a new DML query for processing; and analyzing, by the processor, the new DML query using the data model to make DQL query invalidation decisions.

### CROSS-REFERENCE TO RELATED APPLICATION

This application claims priority under 35 USC § 119(e) to U.S. Provisional Application No. 63/785,695, filed on Apr. 9, 2025, entitled “OBSERVATION-BASED CACHE INVALIDATION SYSTEM,” the contents of which are incorporated herein by reference in its entirety.

### BACKGROUND

The present disclosure relates to database cache invalidation systems, and more particularly to an observation-based cache invalidation system that uses probabilistic modeling and query relationship tracking to reduce over-invalidation and improve cache performance by selectively invalidating cached data query language (DQL) queries based on observed relationships with data manipulation language (DML) queries.

Database caching systems are widely used to improve application performance by storing frequently accessed query results in memory, thereby reducing the need to repeatedly execute expensive database operations. These systems typically maintain a cache of data query language (DQL) queries, such as SELECT statements, along with their corresponding result sets or payloads. When applications request data that has been previously cached, the system can return the stored results without accessing the underlying database, resulting in faster response times and reduced database load.

Cache invalidation represents one of the most challenging aspects of database caching systems. When data manipulation language (DML) queries, such as INSERT, UPDATE, or DELETE operations, modify the underlying database, cached query results may become stale or inconsistent with the current state of the data. Cache invalidation determines which cached queries should be marked as expired or removed when such modifications occur.

Traditional cache invalidation approaches often rely on analyzing the structural components of queries, including accessed columns and query conditions such as WHERE clauses. These systems typically compare the columns and conditions between incoming DML queries and cached DQL queries to determine potential overlaps in the underlying data. When an overlap is detected or cannot be ruled out with certainty, the cached query is invalidated to maintain data consistency.

However, conventional invalidation mechanisms face several performance and accuracy challenges. Many systems perform full scans of the entire cache for each DML query, comparing accessed columns and conditions across all cached entries. This approach can be computationally expensive, particularly as cache sizes grow, leading to increased processing overhead and potential performance bottlenecks.

Additionally, traditional invalidation logic often errs on the side of caution to maintain data consistency, leading to over-invalidation scenarios where cached queries are invalidated even when the underlying data relationships would not actually affect the query results. This conservative approach can result in reduced cache hit rates and diminished overall system performance, as queries that could have been served from cache are unnecessarily re-executed against the database.

The complexity of accurately determining data relationships between queries compounds these challenges. In many cases, structural analysis of query components may indicate potential overlaps that do not actually exist in the underlying data, or conversely, may fail to detect subtle relationships that could affect query results.

### SUMMARY

In an embodiment, a cache invalidation method comprises tracking, by a processor, query patterns to identify invalidation relationships between a plurality of data manipulation language (DML) queries and payload changes of a plurality of data query language (DQL) queries stored in a query cache; generating, by the processor, a plurality of DML-DQL pairs based on the invalidation relationships, each of the plurality of DML-DQL pairs represents a unique pairing of a DML query from the plurality of DML queries and a DQL query from the plurality of DQL queries; generating, by the processor, a data model using the plurality of DML-DQL pairs; receiving, by the processor, a new DML query for processing; and analyzing, by the processor, the new DML query using the data model to make DQL query invalidation decisions.

The data model may comprise a knowledge graph.

The data model may comprise a bipartite graph.

The bipartite graph may comprise: a first set of nodes representing the plurality of DML queries; a second set of nodes representing the plurality of DQL queries; and a plurality of edges connecting the first set of nodes to the second set of nodes, wherein each of the plurality of edges establishes a DML-DQL pair.

Generating the data model using the plurality of DML-DQL pairs may comprise calculating an invalidation probability for each of the plurality of DML-DQL pairs.

The invalidation probability may be derived from a first parameter value representing positive invalidation examples of an observed DML-DQL pair and a second parameter value representing negative invalidation examples of the observed DML-DQL pair.

Analyzing the new DML query using the data model to make DQL query invalidation decisions may comprise: identifying the new DML query and associated one or more DQL queries in the data model; automatically performing DQL query invalidation on any of the one or more DQL queries where an invalidation probability satisfies a first threshold condition; and performing slice comparison between the new DML query and any of the one or more DQL queries where an invalidation probability satisfies a second threshold condition.

Analyzing the new DML query using the data model to make DQL query invalidation decisions may further comprise: performing slice comparison between the new DML query and the plurality of DQL queries in response to determining that the new DML query is not present in the data model.

In an embodiment, a cache invalidation system comprises a query cache for storing a plurality of data query language (DQL) queries; and a processor in communication with the query cache, the processor is configured to: track query patterns to identify invalidation relationships between a plurality of data manipulation language (DML) queries and payload changes of the plurality of DQL queries; generate a plurality of DML-DQL pairs based on the invalidation relationships, each of the plurality of DML-DQL pairs represents a unique pairing of a DML query from the plurality of DML queries and a DQL query from the plurality of DQL queries; generate a bipartite graph using the plurality of DML-DQL pairs; receive a new DML query for processing; and analyze the new DML query using the bipartite graph to make DQL query invalidation decisions.

The bipartite graph may comprise: a first set of nodes representing the plurality of DML queries; a second set of nodes representing the plurality of DQL queries; and a plurality of edges connecting the first set of nodes to the second set of nodes, wherein each of the plurality of edges establishes a DML-DQL pair.

Generating the bipartite graph using the plurality of DML-DQL pairs may comprise calculating an invalidation probability for each of the plurality of DML-DQL pairs.

The invalidation probability may be derived from a first parameter value representing positive invalidation examples of an observed DML-DQL pair and a second parameter value representing negative invalidation examples of the observed DML-DQL pair.

Analyzing the new DML query using the bipartite graph to make DQL query invalidation decisions may comprise: identifying the new DML query and associated one or more DQL queries in the bipartite graph; automatically performing DQL query invalidation on any of the one or more DQL queries where an invalidation probability satisfies a first threshold condition; and performing slice comparison between the new DML query and any of the one or more DQL queries where an invalidation probability satisfies a second threshold condition.

Analyzing the new DML query using the bipartite graph to make DQL query invalidation decisions may further comprise: performing slice comparison between the new DML query and the plurality of DQL queries in response to determining that the new DML query is not present in the bipartite graph.

In an embodiment, a cache invalidation non-transitory storage medium having instructions encoded thereon that, when executed by one or more processors, cause the one or more processors to perform steps comprising: tracking query patterns to identify invalidation relationships between a plurality of data manipulation language (DML) queries and payload changes of a plurality of data query language (DQL) queries stored in a query cache; generating a plurality of DML-DQL pairs based on the invalidation relationships, each of the plurality of DML-DQL pairs represents a unique pairing of a DML query from the plurality of DML queries and a DQL query from the plurality of DQL queries; calculating an invalidation probability for each of the plurality of DML-DQL pairs; generating a data model based on a plurality of invalidation probabilities that correspond to the plurality of DML-DQL pairs; receiving a new DML query for processing; and analyzing the new DML query using the bipartite graph to make DQL query invalidation decisions.

The data model may comprise a bipartite graph.

The bipartite graph may comprise a first set of nodes representing the plurality of DML queries; a second set of nodes representing the plurality of DQL queries; and a plurality of edges connecting the first set of nodes to the second set of nodes, wherein each of the plurality of edges establishes a DML-DQL pair.

Each of the plurality of invalidation probabilities may be derived from a first parameter value representing positive invalidation examples of an observed DML-DQL pair and a second parameter value representing negative invalidation examples of the observed DML-DQL pair.

Analyzing the new DML query using the data model to make DQL query invalidation decisions may comprise: identifying the new DML query and associated one or more DQL queries in the data model; automatically performing DQL query invalidation on any of the one or more DQL queries where an invalidation probability satisfies a first threshold condition; and performing slice comparison between the new DML query and any of the one or more DQL queries where an invalidation probability satisfies a second threshold condition.

Analyzing the new DML query using the data model to make DQL query invalidation decisions may further comprise: performing slice comparison between the new DML query and the plurality of DQL queries in response to determining that the new DML query is not present in the data model.

### BRIEF DESCRIPTION OF DRAWINGS

A general architecture that implements the various features of the disclosure will now be described with reference to the drawings. The drawings and the associated descriptions are provided to illustrate example embodiments of the disclosure and not to limit the scope of the disclosure. Throughout the drawings, reference numbers are reused to indicate correspondence between referenced elements.

FIG. 1 illustrates an example query cache management system 100 in accordance with some embodiments described herein;

FIG. 2 illustrates an example cache invalidation process 200 in accordance with some embodiments described herein;

FIG. 3 illustrates an example bipartite graph 300 in accordance with some embodiments described herein;

FIG. 4 illustrates an example cache invalidation statistics table 400 in accordance with some embodiments described herein; and

FIG. 5 illustrates an example computing environment with an example computer device suitable for use in some example embodiments.

### DETAILED DESCRIPTION

The following detailed description provides details of the figures and example embodiments of the present application. Reference numerals and descriptions of redundant elements between figures are omitted for clarity. Terms used throughout the description are provided as examples and are not intended to be limiting. For example, the use of the term “automatic” may involve fully automatic or semi-automatic embodiments involving user or administrator control over certain aspects of the embodiment, depending on the desired embodiment of one of the ordinary skills in the art practicing embodiments of the present application. Selection can be conducted by a user through a user interface or other input means, or can be implemented through a desired algorithm. Example embodiments as described herein can be utilized either singularly or in combination and the functionality of the example embodiments can be implemented through any means according to the desired embodiments.

The examples and embodiments described herein are provided for illustrative purposes only and are not intended to limit the scope of the subject matter. Certain details or components may be omitted where they are well-understood by those skilled in the art, and the described subject matter may be implemented in various configurations or arrangements without departing from its scope. Modifications, substitutions, or rearrangements of the described features and processes are contemplated and fall within the spirit and scope of the subject matter as defined by the claims.

According to an aspect of the present disclosure, a probabilistic invalidation system that leverages a knowledge graph to model relationships between DML and DQL queries is provided. The system employs a bipartite graph structure, where one set of nodes represents DML queries, and the other set of nodes represents DQL queries. Edges between these nodes are annotated with parameters of beta distributions, which encode the likelihood that a specific DML query invalidates the results of a specific DQL query. Cached results of DQL queries are rendered stale and invalidated when underlying data are modified by DML queries. When a DQL query is marked as stale or invalid, the results associated with the DQL query are refetched from the source, the database. The system continuously monitors production database traffic, detecting executions of DML and DQL queries and observing payload changes in cached results. For each detected DML execution, the system identifies DQL queries whose cached payloads change as a result, forming DML-DQL pairs. The parameters of the beta distribution for each pair are incrementally updated based on monitored invalidating and non-invalidating events, allowing the knowledge graph to reflect the current probabilistic relationships between queries.

This approach enables the cache layer to make more informed invalidation decisions. When a DML query is executed, the system consults the knowledge graph to determine the probability that each cached DQL result is affected. If the probability exceeds a configurable threshold, the corresponding cache entry is invalidated; otherwise, the cache entry may be retained, reducing unnecessary evictions. The system can further optimize performance by storing binary values on edges when the probability remains consistently high or low, allowing for immediate invalidation or retention without additional computation. For cases where the probability is uncertain, the system can sample from the beta distribution and apply risk-tolerance policies, enabling clients to balance data consistency and performance according to their specific requirements.

By combining probabilistic modeling and observation-based learning, the described system addresses the limitations of conventional invalidation techniques. Utilization of a novel data model generated based on monitored DML-DQL pairings for cache invalidation reduces over-invalidation and under-invalidation, minimizes computational overhead, and improves cache hit rates, thereby providing a more efficient, adaptive, and scalable caching solution for modern data-driven applications.

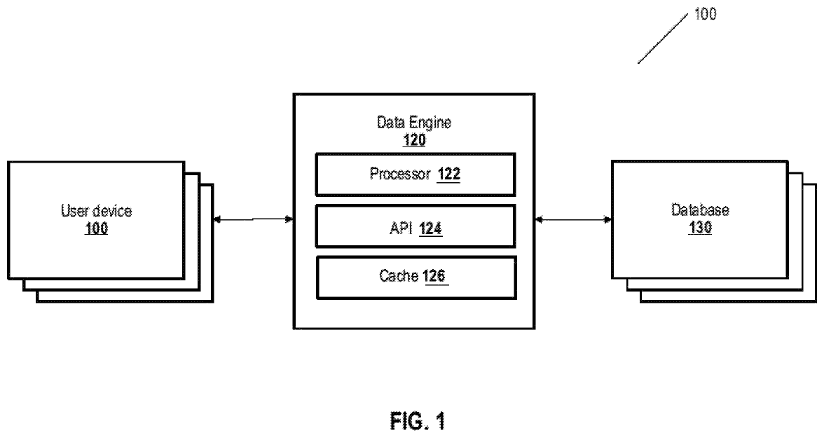

FIG. 1 illustrates an example query cache management system 100 in accordance with some embodiments described herein. As illustrated in FIG. 1, the query cache management system 100 may include components such as, but not limited to, one or more user devices 110, a data engine 120, a database 130, etc. The one or more user devices 110 communicates with the data engine 120 and the database 130 via one or more networks. In particular, the one or more user devices may issue application programming interface (API) calls requesting data operations to the data engine 120 and the database 130 via one or more networks to access stored data or triggering other data functions/operations. The one or more networks may comprise internet, local area network (LAN), wide area network (WAN), telephonic network, cellular network, satellite network, etc.

User(s) of the one or more user devices 110 may specify the information that is needed through one or more applications operating on the user devices 110. In turn, application API calls are then issued through the applications from the user devices 110 to destinations such as the data engine 120 and the database 130. Examples of the one or more user devices 110 may include, but not limited to mobile devices (e.g. smartphones, devices in vehicle and other machine, tablets, notebooks, laptops, personal computers, etc.), and devices not designed for mobility (e.g. desktop computers, information kiosks, televisions, etc.) that are capable of wired or wireless communication.

The data engine 120 is a proxy service that facilitates performance of data operations between the one or more user devices 110 and the database 130. For example, receiving an SQL query from a user device 110 and communicating the query for a data operation to be performed by the database 130 (e.g. data retrieval). The data engine 120 may be implemented on a platform comprising one or more servers, and may include components such as, but not limited to, a processor 122, an application programming interface (API) 124, one or more caches 126, etc.

The API 124 receives requests/calls (queries) from the one or more user devices 110 (e.g. through applications executed on the one or more user devices 110) for performing data operations such as, but not limited to, data storing and retrieval in association with the data engine 120 and the database 130. The one or more caches 126 are wire protocol-compatible database caches that ensure effective communication/interoperability between the one or more user devices 110 and the database 130.

In some embodiments, the one or more caches 126 are memory caches for storing/caching queries, query hashes, and query results received from the database 130 for future retrieval. Only queries that have been determined to be frequently accessed (e.g., executed more than once) are stored/cached in the one or more caches 126. In response to receiving an API call for a data operation (query) from the one or more user devices 110 at the API 124, the processor 122 first checks the one or more caches 126 to determine whether the same query and results associated with the query have already been cached. If the processor 122 determines that the results of the data operation are cached in the one or more caches 126, then the processor 122 retrieves the results from the one or more caches 126 without needing to access the database 130 to perform query parsing and retrieve such results. By so doing, response time is significantly improved while computational resources wasted through parsing and data manipulation/processing of the same queries can be reduced.

Communications between the one or more user devices 110, the data engine 120, and the database 130 are facilitated via one or more networks. The one or more networks may comprise internet, local area network (LAN), wide area network (WAN), telephonic network, cellular network, satellite network, etc., utilizing any transmission protocols such as, but not limited to, Hypertext Transfer Protocol (HTTP), HTTP Secure (HTTPS), Transmission Control Protocol (TCP), File Transfer Protocol (FTP), FTP Secure (FTPS), SSH FTP (SFTP), Trivial File Transfer Protocol (TFTP), etc.

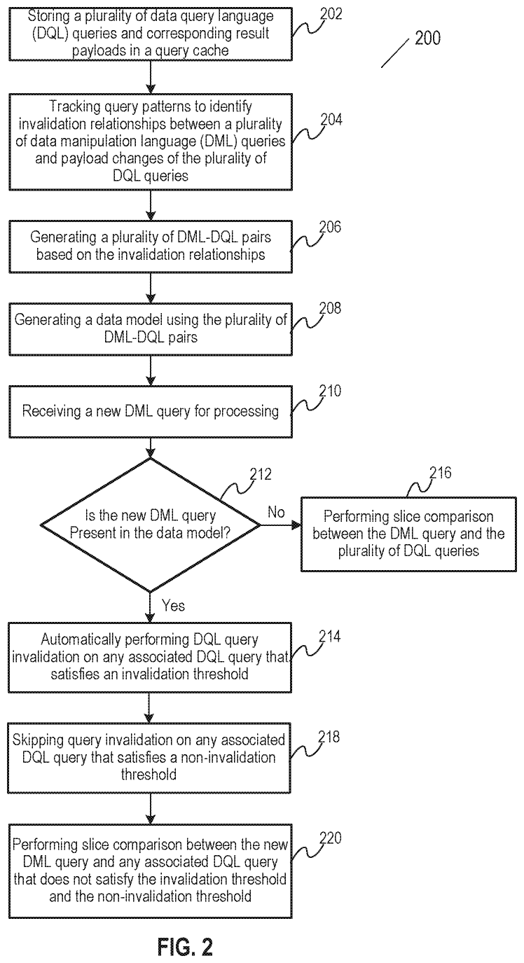

FIG. 2 illustrates an example cache invalidation process 200 in accordance with some embodiments described herein. The cache invalidation process 200 is performed by the data engine 120 of FIG. 1. As shown in FIG. 2, the cache invalidation process begins with the storage of data query language (DQL) queries and their corresponding result payloads in a query cache at block 202. In particular, storing frequently accessed DQL query results in the query cache ensures that subsequent requests can be served without repeatedly accessing the underlying database, thereby improving response time and reducing computational overhead.

Next, tracking query patterns are tracked to identify invalidation relationships between a plurality of data manipulation language (DML) queries and payload changes of the stored DQL queries at block 204. Specifically, DML query execution patterns and instances in which DML queries produce modifications to the payloads of cached DQL queries are monitored by the data engine 120. As a result, empirical data on query interdependencies is gathered and made available for further analysis.

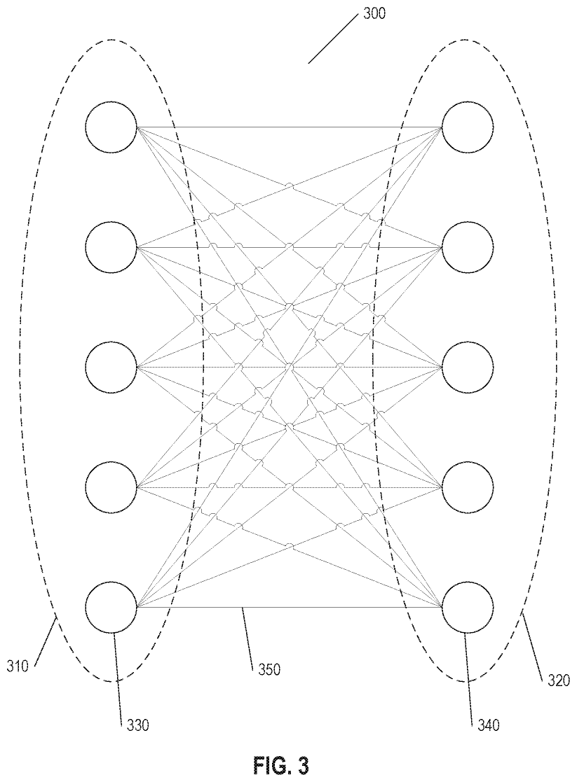

A plurality of DML-DQL pairs are generated based on the invalidation relationships at block 206. Each of the plurality of DML-DQL pairs represents a unique pairing of a DML query from the plurality of DML queries and a DQL query from the plurality of DQL queries. A data model is then generated using the plurality of DML-DQL pairs at block 208. In some embodiments, the data model is a knowledge graph. The knowledge graph may be a bipartite graph, a specialized graph data structure, that comprises nodes representing both DML and DQL queries. Illustrative aspects of a bipartite graph will be described with regard to FIG. 3.

FIG. 3 illustrates an example bipartite graph 300 in accordance with some embodiments described herein. The bipartite a data structure with two partitions 310 and 320. The first partition, partition 310, comprises of nodes representing DML queries (DML query nodes 330), while the other partition, partition 320, comprises of nodes representing DQL queries (DQL query nodes 340). Each edge 350 in the bipartite graph 300 connects a DML query node 330 to a DQL query node 340, representing the potential for a specific DML query to invalidate the results of a specific DQL query, with no edges connecting nodes within the same partition.

In some embodiments, the edges 350 are annotated with invalidation probabilities modeled from beta distributions. The beta distribution is a continuous probability distribution defined on the interval [0, 1], parameterized by two positive real numbers, α and β. α and β represent the counts of invalidating and non-invalidating events, respectively, for a given DML-DQL query pair. The probability density function of the beta distribution is given by:

$$f ( x ; α , β ) = \frac{{{x}^{α - 1} ( 1 - x )}^{β - 1}}{B ( α , β )}$$

where B(α,β) is the beta function that normalizes the distribution. In the context of the bipartite graph, the beta distribution models the uncertainty and likelihood that execution of a DML query will invalidate the results of a DQL query, with the mean of the distribution

$$\frac{α}{α + β}$$

serving as an estimate of the invalidation probability.

For example, if a particular edge in the bipartite graph has observed 8 invalidating events and 2 non-invalidating events for a given DML-DQL query pair, the parameters are α=8 and β=2. The estimated invalidation probability is calculated as

$$p = \frac{α}{α + β} = \frac{8}{8 + 2} = 0.8 ,$$

indicating an 80% likelihood that execution of the DML query will invalidate the DQL query's cached result. If α=3 and β=7, the estimated invalidation probability is

$$p = \frac{3}{3 + 7} = 0.3 ,$$

or 30%. If both α and β are equal, such as α=5 and β=5, the estimated invalidation probability is

$$p = \frac{5}{5 + 5} = 0.5 ,$$

or 50%. These numerical examples demonstrate how the beta distribution parameters on each edge provide a dynamic and interpretable estimate of the likelihood that a DML query will render a DQL query's cached result stale.

The sample size, defined as the sum of α and β, directly impacts both the estimated invalidation probability and the confidence in that estimate for each edge in the bipartite graph. When the sample size is small (for example, α=1 and β=1), the estimated probability

$$p = \frac{1}{1 + 1} = 0.5$$

reflects high uncertainty, and the variance of the beta distribution is relatively large, indicating low confidence in the invalidation likelihood. As more invalidating and non-invalidating events are observed and the sample size increases (for example, α=50 and β=50), the estimated probability

$$p = \frac{50}{50 + 50} = 0.5$$

remains the same, but the variance decreases, resulting in higher confidence that the true invalidation probability is close to the estimated value. In another embodiment, if the sample size is large and the ratio of α to β is skewed (for example, α=90 and β=10), the estimated probability

$$p = \frac{90}{90 + 10} = 0.9$$

is both high and reliable, as the large sample size reduces the impact of random fluctuations. Thus, the beta distribution not only provides an estimate of invalidation probability but also incorporates the effect of sample size, allowing the system to adjust invalidation decisions based on both the probability and the confidence derived from the observed data.

In some embodiments, each edge is annotated with parameters α and β of the beta distribution. In some other embodiments, the edges are stored as maps for the left nodes/DML nodes (e.g., (right node; invalidity probability)). In some embodiments, the system supports incremental and batched updates to the knowledge graph. Specifically, aggregating observation records and updating beta distribution parameters in batches. This reduces computational overhead and avoids contention during graph updates, making the approach suitable for high-throughput environments.

At block 210, the system receives a new DML query for processing. On receipt of the new DML query, the system then determines whether the DML query is present in the data model at block 212. If the DML query is not present, the system defaults to applying slice comparison logic between the DML query and the plurality of DQL queries at block 216. Specifically, structural components of the incoming DML query and all cached DQL queries are parsed by the data engine 120 to detect potential overlaps in accessed data fields.

If the DML query is present in the data model, query invalidation is automatically performed on any associated DQL query that satisfies an invalidation threshold at block 214. For instance, if the invalidation probability of an associated DQL query satisfies a predetermined confidence level/threshold indicating high probability of invalidation, then the associated DQL query is immediately invalidated without further analysis. In some embodiments, the predetermined confidence level/threshold may be adjusted based on user preference. Accordingly, computational overhead is reduced and data consistency is maintained. The process then continues to block 218 where query invalidation is skipped for any associated DQL query that satisfied a non-invalidation threshold. For instance, if the invalidation probability of an associated DQL query satisfies a predetermined confidence level/threshold indicating low probability of invalidation (e.g., 0% or 5%), then query invalidation is skipped without further analysis.

At block 220, slice comparison is performed between the new DML query and any associated DQL query that does not satisfy both the invalidation threshold and the non-invalidation threshold. Specifically, this involves examining the accessed columns and query conditions of both the DML query and the potentially affected DQL queries to assess whether invalidation is required. In some embodiments, blocks 214, 216, and 216 may be performed in different orders. This multi-phase approach is designed to balance computational efficiency with data consistency, reduce over-invalidation and under-invalidation, and enhance overall cache performance.

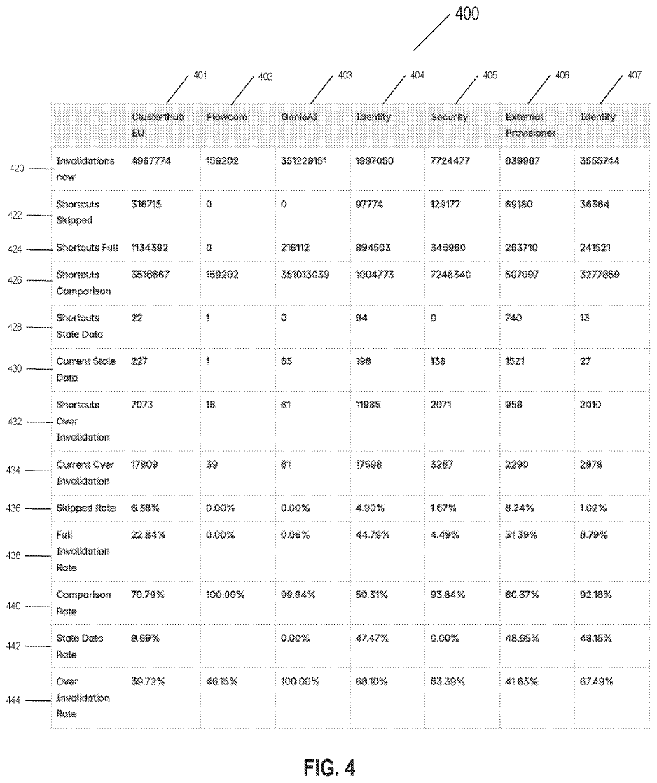

FIG. 4 illustrates an example cache invalidation statistics table 400 in accordance with some embodiments described herein. As illustrated in FIG. 4, the table 400 summarizes cache invalidation metrics across six distinct database workload environments, including Clusterhub EU 401, Flowcore 402, GenieAI 403, Identity (Identity 404 and Identity 407), Security 405, and External Provisioner 406. In particular, the table 400 provides a detailed breakdown of various metrics related to cache entry invalidation events, thereby highlighting the performance and accuracy of the system in different operational contexts.

The data in the table 400 demonstrates how the cache invalidation system performs across these diverse environments by quantifying the outcomes of different invalidation strategies and their impact on cache consistency and efficiency. The information and organization utilized in table 400 is illustrative in nature and should not be construed as limiting. Accordingly, different organization of the data identified in table 400 or additional or alternative data may be utilized.

Invalidations now 420 shows the total number of cache invalidation events triggered by the system's logic. This metric reflects the overall activity of the invalidation process and the system's responsiveness to detected changes in the underlying data.

Shortcuts skipped 422 indicates the number of times the system avoided invalidation because the knowledge graph determined a low probability of stale data. This data point highlights the system's ability to reduce unnecessary cache evictions, thereby improving cache hit rates and reducing computational overhead.

Shortcuts full 424 represents the number of immediate invalidations performed when the knowledge graph indicated a high probability of invalidation. This demonstrates the system's ability to take prompt action when there is strong evidence that cached data has become stale, supporting data consistency.

Shortcuts comparison 426 details the number of cases where the system reverted to slice comparison logic due to uncertainty in the knowledge graph. This metric illustrates how frequently the system relies on structural analysis, which is more computationally intensive, when probabilistic modeling does not provide a clear decision.

Shortcuts stale data 428 and current state data 430 record the number of cases where shortcut invalidation and current invalidation logic, respectively, resulted in stale data remaining in the cache. These metrics provide insight into the risk of under-invalidation and the effectiveness of each approach in maintaining cache freshness.

Shortcuts over invalidation 432 and current over invalidation 434 quantify the number of over-invalidation events, where cache entries were invalidated unnecessarily. Comparing these values allows assessment of how well the system reduces wasteful evictions compared to previous logic.

Skipped rate 436, full invalidation rate 438, and comparison rate 440 present the percentage of events corresponding to skipped invalidations, full invalidations, and slice comparisons, respectively. These rates provide a proportional view of how the system balances efficiency and accuracy in the invalidation decisions.

Stale data rate 442 and over invalidation rate 444 show the percentage of events resulting in stale data and unnecessary invalidations, respectively. These metrics play a significant role in evaluating the trade-off between cache consistency and performance.

Overall, the data in table 400 reveals the operational characteristics of the invalidation system, including the system's ability to minimize over-invalidation, reduce stale data, and optimize cache performance. By comparing these metrics across different workload environments, the table demonstrates how the system adapts and performs efficiently in real-world scenarios.

The foregoing example embodiments may have various benefits and advantages. For example, the approach enables the cache layer to make more informed invalidation decisions. When a DML query is executed, the system consults the knowledge graph to determine the probability that each cached DQL result is affected. If the probability exceeds a configurable threshold, the corresponding cache entry is invalidated; otherwise, the cache entry may be retained, reducing unnecessary evictions.

In addition, The bipartite graph structure allows for efficient lookups and targeted invalidation actions, minimizing the need for full cache scans and expensive slice comparisons. Aggregating observation records and updating beta distribution parameters in batches help reduce computational overhead and avoids contention during graph updates, making the approach suitable for high-throughput environments.

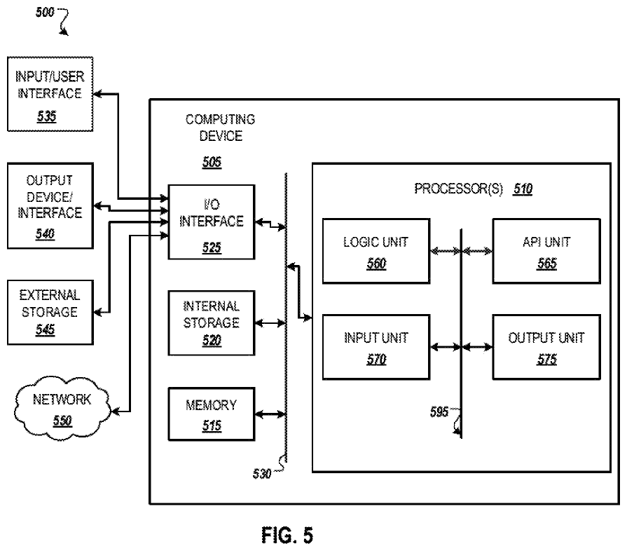

FIG. 5 illustrates an example computing environment with an example computer device suitable for use in some example embodiments. Computer device 505 in computing environment 500 can include one or more processing units, cores, or processors 510, memory 515 (e.g., RAM, ROM, and/or the like), internal storage 520 (e.g., magnetic, optical, solid-state storage, and/or organic), and/or IO interface 525, any of which can be coupled on a communication mechanism or bus 530 for communicating information or embedded in the Computer device 505. IO interface 525 is also configured to receive images from cameras or provide images to projectors or displays, depending on the desired embodiment.

Computer device 505 can be communicatively coupled to input/user interface 535 and output device/interface 540. Either one or both of the input/user interface 535 and output device/interface 540 can be a wired or wireless interface and can be detachable. Input/user interface 535 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 540 may include a display, television, monitor, printer, speaker, braille, or the like. In some example embodiments, input/user interface 535 and output device/interface 540 can be embedded with or physically coupled to the computer device 505. In other example embodiments, other computer devices may function as or provide the functions of input/user interface 535 and output device/interface 540 for a computer device 505.

Examples of computer device 505 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 505 can be communicatively coupled (e.g., via IO interface 525) to external storage 545 and network 550 for communicating with any number of networked components, devices, and systems, including one or more computer devices of the same or different configuration. Computer device 505 or any connected computer device can be functioning as, providing services of, or referred to as a server, client, thin server, general machine, special-purpose machine, or another label.

IO interface 525 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 500. Network 550 can be any network or combination of networks (e.g., the Internet, local area network, wide area network, a telephonic network, a cellular network, satellite network, and the like).

Computer device 505 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 505 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 510 can execute under any operating system (OS) (not shown), in a native or virtual environment. One or more applications can be deployed that include logic unit 560, application programming interface (API) unit 565, input unit 570, output unit 575, and inter-unit communication mechanism 595 for the different units to communicate with each other, with the OS, and with other applications (not shown). The described units and elements can be varied in design, function, configuration, or embodiment and are not limited to the descriptions provided. Processor(s) 510 can be in the form of hardware processors such as central processing units (CPUs) or in a combination of hardware and software units.

In some example embodiments, when information or an execution instruction is received by API unit 565, it may be communicated to one or more other units (e.g., logic unit 560, input unit 570, output unit 575). In some instances, logic unit 560 may be configured to control the information flow among the units and direct the services provided by API unit 565, the input unit 570, the output unit 575, in some example embodiments described above. For example, the flow of one or more processes or embodiments may be controlled by logic unit 560 alone or in conjunction with API unit 565. The input unit 570 may be configured to obtain input for the calculations described in the example embodiments, and the output unit 575 may be configured to provide an output based on the calculations described in example embodiments.

Processor(s) 510 can be configured to track query patterns to identify invalidation relationships between a plurality of data manipulation language (DML) queries and payload changes of a plurality of data query language (DQL) queries stored in a query cache as illustrated in FIG. 2. The processor(s) 510 may also be configured to generate a plurality of DML-DQL pairs based on the invalidation relationships, each of the plurality of DML-DQL pairs represents a unique pairing of a DML query from the plurality of DML queries and a DQL query from the plurality of DQL queries as illustrated in FIG. 2. The processor(s) 510 may also be configured to generate a data model using the plurality of DML-DQL pairs as illustrated in FIG. 2. The processor(s) 510 may also be configured to receive a new DML query for processing The processor(s) 510 may also be configured to analyze the new DML query using the data model to make DQL query invalidation decisions as illustrated in FIG. 2.

The processor(s) 510 may also be configured to calculate an invalidation probability for each of the plurality of DML-DQL pairs as illustrated in FIG. 2. The processor(s) 510 may also be configured to identify the new DML query and associated one or more DQL queries in the data model as illustrated in FIG. 2. The processor(s) 510 may also be configured to automatically perform DQL query invalidation on any of the one or more DQL queries where an invalidation probability satisfies a first threshold condition as illustrated in FIG. 2. The processor(s) 510 may also be configured to perform slice comparison between the new DML query and any of the one or more DQL queries where an invalidation probability satisfies a second threshold condition as illustrated in FIG. 2.

The processor(s) 510 may also be configured to perform slice comparison between the new DML query and the plurality of DQL queries in response to determining that the new DML query is not present in the data model as illustrated in FIG. 2.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example embodiments, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example embodiments may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software embodiments that involve instructions that perform the operations of the desired embodiment.

Various general-purpose systems may be used with programs and modules in accordance with the examples herein, or it may prove convenient to construct a more specialized apparatus to perform desired method steps. In addition, the example embodiments are not described with reference to any particular programming language. It will be appreciated that a variety of programming languages may be used to implement the teachings of the example embodiments as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example embodiments may be implemented using circuits and logic devices (hardware), while other aspects may be implemented using instructions stored on a machine-readable medium (software), which if executed by a processor, would cause the processor to perform a method to carry out embodiments of the present application. Further, some example embodiments of the present application may be performed solely in hardware, whereas other example embodiments may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other embodiments of the present application will be apparent to those skilled in the art from consideration of the specification and practice of the teachings of the present application. Various aspects and/or components of the described example embodiments may be used singly or in any combination. It is intended that the specification and example embodiments be considered as examples only, with the true scope and spirit of the present application being indicated by the following claims.

What is claimed is:

1. A cache invalidation method, comprising:
tracking, by a processor, query patterns to identify invalidation relationships between a plurality of data manipulation language (DML) queries and payload changes of a plurality of data query language (DQL) queries stored in a query cache;
generating, by the processor, a plurality of DML-DQL pairs based on the invalidation relationships, each of the plurality of DML-DQL pairs represents a unique pairing of a DML query from the plurality of DML queries and a DQL query from the plurality of DQL queries;
generating, by the processor, a data model using the plurality of DML-DQL pairs;
receiving, by the processor, a new DML query for processing; and
analyzing, by the processor, the new DML query using the data model to make DQL query invalidation decisions.

2. The method of claim 1, wherein the data model comprises a knowledge graph.

3. The method of claim 1, wherein the data model comprises a bipartite graph.

4. The method of claim 3, wherein the bipartite graph comprises:
a first set of nodes representing the plurality of DML queries;
a second set of nodes representing the plurality of DQL queries; and
a plurality of edges connecting the first set of nodes to the second set of nodes,
wherein each of the plurality of edges establishes a DML-DQL pair.

5. The method of claim 4, wherein the generating the data model using the plurality of DML-DQL pairs comprises calculating an invalidation probability for each of the plurality of DML-DQL pairs.

6. The method of claim 5, further comprising deriving the invalidation probability from a first parameter value representing positive invalidation examples of an observed DML-DQL pair and a second parameter value representing negative invalidation examples of the observed DML-DQL pair.

7. The method of claim 1, wherein the analyzing the new DML query using the data model to make DQL query invalidation decisions comprises:
identifying the new DML query and associated one or more DQL queries in the data model;
automatically performing DQL query invalidation on any of the one or more DQL queries where an invalidation probability satisfies a first threshold condition; and
performing slice comparison between the new DML query and any of the one or more DQL queries where an invalidation probability satisfies a second threshold condition.

8. The method of claim 7, wherein the analyzing the new DML query using the data model to make DQL query invalidation decisions further comprises:
performing slice comparison between the new DML query and the plurality of DQL queries in response to determining that the new DML query is not present in the data model.

9. A cache invalidation system, comprising:
a query cache for storing a plurality of data query language (DQL) queries; and
a processor in communication with the query cache, the processor is configured to:
track query patterns to identify invalidation relationships between a plurality of data manipulation language (DML) queries and payload changes of the plurality of DQL queries;
generate a plurality of DML-DQL pairs based on the invalidation relationships, each of the plurality of DML-DQL pairs represents a unique pairing of a DML query from the plurality of DML queries and a DQL query from the plurality of DQL queries;
generate a bipartite graph using the plurality of DML-DQL pairs;
receive a new DML query for processing; and
analyze the new DML query using the bipartite graph to make DQL query invalidation decisions.

10. The system of claim 9, wherein the bipartite graph comprises:
a first set of nodes representing the plurality of DML queries;
a second set of nodes representing the plurality of DQL queries; and
a plurality of edges connecting the first set of nodes to the second set of nodes,
wherein each of the plurality of edges establishes a DML-DQL pair.

11. The system of claim 10, wherein the system generates the bipartite graph using the plurality of DML-DQL pairs comprises by calculating an invalidation probability for each of the plurality of DML-DQL pairs.

12. The system of claim 11, wherein the invalidation probability is derived from a first parameter value representing positive invalidation examples of an observed DML-DQL pair and a second parameter value representing negative invalidation examples of the observed DML-DQL pair.

13. The system of claim 9, wherein system analyzes the new DML query using the bipartite graph to make DQL query invalidation decisions by:
identifying the new DML query and associated one or more DQL queries in the bipartite graph;
automatically performing DQL query invalidation on any of the one or more DQL queries where an invalidation probability satisfies a first threshold condition; and
performing slice comparison between the new DML query and any of the one or more DQL queries where an invalidation probability satisfies a second threshold condition.

14. The system of claim 13, wherein the system analyzes the new DML query using the bipartite graph to make DQL query invalidation decisions by performing slice comparison between the new DML query and the plurality of DQL queries in response to determining that the new DML query is not present in the bipartite graph.

15. A non-transitory storage medium having instructions encoded thereon that, when executed by one or more processors, cause the one or more processors to perform steps comprising:
calculating an invalidation probability for each of a plurality of pairs of data corresponding to data manipulation language (DML) queries and payload changes of a plurality of data query language (DQL) queries, wherein each of the plurality of DML-DQL pairs represents a unique pairing of a DML query from the plurality of DML queries and a DQL query from the plurality of DQL queries;
generating a data model based on a plurality of invalidation probabilities that correspond to the plurality of DML-DQL pairs;
receiving a new DML query for processing; and
analyzing the new DML query using the data model to make DQL query invalidation decisions.

16. The non-transitory storage medium of claim 15, further comprising tracking query patterns to identify invalidation relationships between the plurality of DML queries and payload changes of a plurality of DQL queries stored in a query cache.

17. The non-transitory storage medium of claim 16, wherein the data model corresponds to a bipartite graph, the bipartite graph comprising:
a first set of nodes representing the plurality of DML queries;
a second set of nodes representing the plurality of DQL queries; and
a plurality of edges connecting the first set of nodes to the second set of nodes,
wherein each of the plurality of edges establishes a DML-DQL pair.

18. The non-transitory storage medium of claim 15, wherein each of the plurality of invalidation probabilities is derived from a first parameter value representing positive invalidation examples of an observed DML-DQL pair and a second parameter value representing negative invalidation examples of the observed DML-DQL pair.

19. The non-transitory storage medium of claim 15, wherein the analyzing the new DML query using the data model to make DQL query invalidation decisions comprises:
identifying the new DML query and associated one or more DQL queries in the data model;
automatically performing DQL query invalidation on any of the one or more DQL queries where an invalidation probability satisfies a first threshold condition; and
performing slice comparison between the new DML query and any of the one or more DQL queries where an invalidation probability satisfies a second threshold condition.

20. The non-transitory storage medium of claim 19, wherein the analyzing the new DML query using the data model to make DQL query invalidation decisions further comprises:
performing slice comparison between the new DML query and the plurality of DQL queries in response to determining that the new DML query is not present in the data model.
